(19) United States
(12) Patent Application Publication
(10) Pub. No.: US 2014/0139491 A1
(43) Pub. Date: May 22, 2014

(54) COMMUNICATION METHOD OF DISPLAY APPARATUS AND DISPLAY APPARATUS THEREFOR

(71) Applicant: SAMSUNG ELECTRONICS CO., LTD., Suwon-si (KR)

(72) Inventors: Young-ran HAN, Seoul (KR); Hyun-mook CHOI, Seoul (KR); Jeong-hyun PARK, Daegu (KR); Kyoung-oh CHOI, Seoul (KR)

(73) Assignee: SAMSUNG ELECTRONICS CO., LTD., Suwon-si (KR)

(21) Appl. No.: 14/087,498

(22) Filed: Nov. 22, 2013

(30) Foreign Application Priority Data
Nov. 22, 2012 (KR) 10-2012-0133027

(51) Int. Cl. G06F 3/042

(52) U.S. Cl. CPC G06F 3/042
USPC 345/175; 345/173

(57) ABSTRACT

A display apparatus is disclosed. The display apparatus includes a display panel; a touch sensor which senses whether a display screen of an external display apparatus is touched on the display panel; and a controller which transmits first data to the external display apparatus through a touch area between the display panel and the external display apparatus, and obtains second data transmitted from the external display apparatus using the touch sensor.

### CROSS-REFERENCE TO RELATED APPLICATIONS

This application claims priority from Korean Patent Application No. 10-2012-133027, filed on Nov. 22, 2012, in the Korean Intellectual Property Office, the disclosure of which is incorporated herein by reference in its entirety.

### BACKGROUND 1. Field

Methods and apparatuses consistent with the exemplary embodiments relate to a communication method between display apparatuses and a display apparatus therefor, and more particularly, to a communication method between display apparatuses using visible light or infrared (IR) light, and a display apparatus therefor.

2. Description of the Related Art

In a short distance communication between related art display apparatuses, wireless communication technologies are used. For example, short distance wireless communication technologies such as Wifi, Bluetooth, Zigbee, etc. are generally used to transmit and receive data between the related art display apparatuses. Such a wireless communication method using radio frequency (RF) requires an additional hardware system, such as a separate wireless communication chip for each device, and also requires a wireless bandwidth to be set in advance for transmitting data.

Meanwhile, recently, a visual light communication (VLC) technology has been introduced, which provides an environment for transceiving data using visible light. The visible light communication is a communication method of using light of a visible light band. When light flickers one hundred times or more per second, a human eye cannot recognize the flickering and perceives that the light is continuous. Therefore, when information is stored in the flickering and transmitted, data may be transmitted while a lighting function by the visible light is performed. For this reason, the visible light communication technology draws attention as a next generation communication method.

The visible light communication is a method of adjusting a pulse signal from a light source of the visible light band and sending data using the adjusted pulse signal. The visible light communication may include a combination of receiving sensors which may receive light signals, respectively. Meanwhile, if the visible light communication may be provided between display apparatuses using a camera sensor or a display panel mounted on the display apparatuses, short-distance communication between the display apparatuses may be performed without requiring an additional chip or hardware system.

### SUMMARY

An aspect of the exemplary embodiments relates to a method of communication between display apparatuses using visible light or infrared (IR) light and a display apparatus therefor.

According to an exemplary embodiment, a display apparatus may include a display panel; a touch sensor which senses whether a display screen of an external display apparatus touches the display panel; and a controller which transmits first data to the external display apparatus through a touch area between the display panel and the display screen of the external display apparatus, and obtains second data transmitted from the external display apparatus using the touch sensor.

The controller may generate a first patch image corresponding to the first data and display the generated first patch image on the touch area, and when a second patch image corresponding to the second data is displayed on the display screen of the external display apparatus and is sensed by the touch sensor, the controller may decode the second patch image to obtain the second data.

The display apparatus may further include a backlight unit which provides backlight to the display panel using a plurality of light emitting diodes, wherein the controller may control on/off of a light emitting diode corresponding to the touch area among the plurality of light emitting diodes according to the first data, and when a light signal which the external display apparatus emits according to the second data is entered to the touch sensor, the controller may demodulate the light signal and obtains the second data.

The display apparatus may further include a backlight unit which provides backlight to the display panel, wherein the controller may control on/off of the backlight unit according to the first data, and when a light signal which the external display apparatus emits according to the second data enters the touch sensor, the controller may demodulate the light signal to obtain the second data.

The touch sensor may include an IR light emitting unit and an IR light receiving unit which are arranged on a back surface of the display panel, and the controller may control on/off of the IR light emitting unit to emit an IR signal according to the first data, and when an IR signal that the external display apparatus emits according to the second data is received through the IR light receiving unit, the controller may demodulate the received IR signal and obtains the second data.

The touch sensor may be arranged on a back surface of the display panel and may be at least one of a camera sensor or photodiode which senses visible light entered through a front surface of the display panel.

The display apparatus may be a table-type display apparatus, and the external display apparatus may be a portable display apparatus.

According to another exemplary embodiment, a communication method of a display apparatus may include determining whether a display screen of an external display apparatus touches a display panel of the display apparatus; if it is determined that the display screen of the external display apparatus touches the display panel, transmitting first data to the external display apparatus through a touch area between the external display apparatus and the display panel; and receiving second data transmitted from the external display apparatus using a touch sensor.

The transmitting may include generating a first patch image corresponding to the first data and displaying the created first patch image within the touch area, and when a second patch image corresponding to the second data is displayed on the display screen of the external display apparatus and is sensed by the touch sensor, the receiving may include decoding the second patch image and obtain the second patch image.

The communication method may further include providing backlight to the display panel using a backlight unit including a plurality of light emitting diodes, and the transmitting may include controlling on/off of a light emitting diode corresponding to the touch area among the plurality of light emitting diodes according to the first data, and when a light signal which the external display apparatus emits according to the second data is entered to the touch sensor, the receiving may include demodulating the light signal to obtain the second data.

The communication method may further include providing backlight to the display panel to the display panel using a backlight unit and the transmitting may include controlling on/off of the backlight unit according to the first data, and when a light signal which the external display apparatus emits according to the second data is entered to the touch sensor, the receiving may include demodulating the light signal to obtain the second data.

The touch sensor may include an IR light emitting unit and an IR light receiving unit which are arranged on a back surface of the display panel, the transmitting may include controlling on/off of the IR light emitting unit to emit an IR signal according to the first data, and when an IR signal which the external display apparatus emits according to the second data is received through the IR light receiving unit, the receiving may include demodulating the received IR signal and obtains the second data.

The touch sensor may be arranged on a back surface of the display panel, and may be at least one of a camera sensor or a photo diode which senses visible light entered through a front surface of the display panel.

The display apparatus may be a table-type display apparatus, and the external display apparatus may be a portable display apparatus.

According to another exemplary embodiment, a non-transitory record medium where a program for performing a communication method of a display apparatus is stored may include touch sensing whether a display screen of an external apparatus touches a display panel of the display apparatus; transmitting first data to the external display apparatus through a touch area between the external display apparatus and the display panel; and receiving second data from the external display apparatus using a touch sensor.

According to another exemplary embodiment, a method of driving a light source of a display apparatus may include determining whether a display screen of an external display apparatus touches a display panel of the display apparatus; and if it is determined that the display screen of the external display apparatus touches the display panel, controlling on/off of at least one light source corresponding to a touch area between the external display apparatus and the display panel according to data to be transmitted to the external display apparatus.

The display apparatus may include a touch sensor arranged on a back surface of the display panel and is at least one of a camera sensor, a photo diode, or an infrared (IR) light sensor, and the determining may be performed by using the touch sensor.

### BRIEF DESCRIPTION OF THE DRAWINGS

The above and/or other aspects of the present disclosure will be more apparent by describing certain present disclosure with reference to the accompanying drawings, in which:

FIG. 1 is a block diagram of a display apparatus according to an exemplary embodiment of the present disclosure;

FIGS. 2A to 2C are views illustrating display apparatuses for performing communication therebetween according to an exemplary embodiment of the present disclosure;

FIGS. 3A to 3D are views for explaining an arrangement of a touch sensor according to an exemplary embodiment of the present disclosure;

FIGS. 4A to 4C are views for explaining communication through a patch image of a display apparatus according to an exemplary embodiment of the present disclosure;

FIGS. 5A and 5B are views illustrating a configuration of a display apparatus according to an exemplary embodiment of the present disclosure;

FIGS. 6A to 6D and FIGS. 7A and 7B are views for explaining a communication method using the display apparatus of FIG. 5;

FIGS. 8A to 8C are views illustrating a configuration of a display apparatus according to another exemplary embodiment of the present disclosure;

FIGS. 9A to 9C are views for explaining a communication method using the display apparatus of FIG. 8; and

FIG. 10 is a flowchart illustrating a method of communication between display apparatuses according to another exemplary embodiment of the present disclosure.

### DETAILED DESCRIPTION

Certain exemplary embodiments are described in detail below with reference to the accompanying drawings.

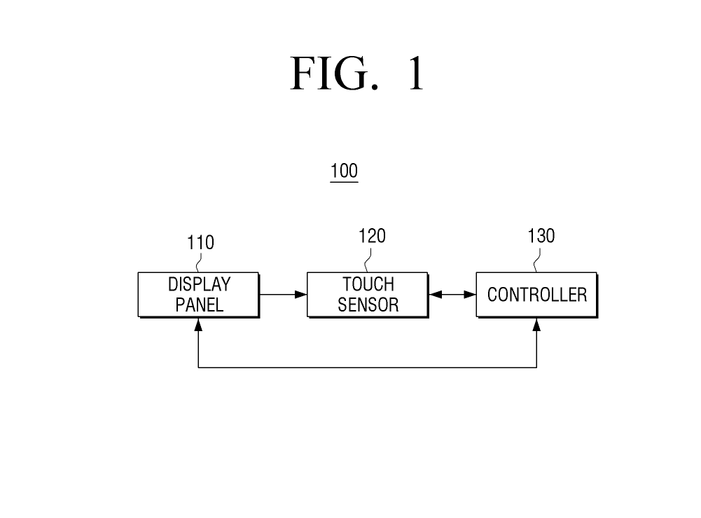

FIG. 1 is a block diagram illustrating a configuration of a display apparatus according to an exemplary embodiment of the present disclosure. According to FIG. 1, a display apparatus 100 includes a display panel 110, a touch sensor 120, and a controller 130.

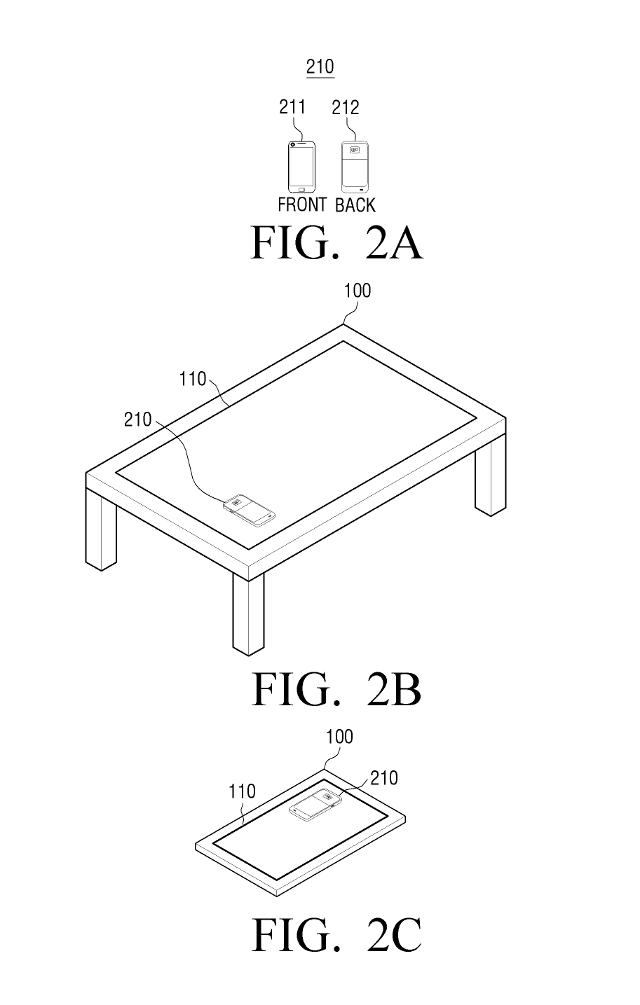

Meanwhile, FIG. 2A to 2C are views illustrating an exemplary embodiment where the display apparatus 100 according to an exemplary embodiment communicates with an external display apparatus 210. With reference to FIGS. 1 and 2A to 2C, each element of the display apparatus 100 and an exemplary embodiment of using the display apparatus 100 will be described.

FIG. 2A shows a front surface 211 and a back surface 212 of the external display apparatus 210, and FIGS. 2B and 2C show a state where the external display apparatus 210 is placed on the display panel 110 of the display apparatus 100 such that the front surface 211 of the external display apparatus 210 faces toward the display panel 110. That is, the display apparatus 100 may communicate with the external display apparatus 210 in a state where the front surface 211 of the external display apparatus 210 and the display panel 110 of the display apparatus 100 contact each other.

In addition, the display apparatus 100 may be a table-type display apparatus, as shown in FIGS. 2B and 2C, but is not limited thereto, and the external display apparatus 210 may be a portable display apparatus, but is not limited thereto. FIG. 2 shows an exemplary embodiment of using the display apparatus 100, but the disclosure is not limited thereto.

Meanwhile, according to FIG. 1, the display panel 110 displays various screens. Particularly, an entire area of the display panel 110 may be divided into a plurality of areas to display a different image in each area. Herein, the image displayed on the display panel 110 may be a first patch image corresponding to first data. The first data is data to be transmitted to the external display apparatus 210, and the first patch image is a representation of an image formed by encoding the first data according to predetermined rules.

To this end, the display panel 110 may be embodied as a liquid crystal display (LCD) formed in various methods such as, for example, a twisted nematic (TN) method, a vertical alignment (VA) method, an in-place-switching (IPS) method, etc.

The touch sensor 120 may sense a touch by an external object including a user's hand on the display panel 110. Particularly, the touch sensor 120 may sense whether the front surface, e.g., a display screen 211 of the external display apparatus touches the display panel 110. In addition, even when a plurality of touches occurs within the display panel 110, the touch sensor 120 may sense each touch. In addition, the touch sensor 120 may also be used to detect second data transmitted from the display apparatus 210.

To this end, the touch sensor 120 may be arranged at a predetermined interval over an entire area of a back side of the display panel 110. The touch sensor 120 may be a camera sensor or a photodiode which senses visible light which is entered through a front surface of the display panel 110. Herein, the camera sensor may be one that uses a charge-coupled device (CCD) or a complementary metal-oxide-semiconductor (CMOS), but is not limited thereto.

Operations of the touch sensor 120 in an exemplary embodiment where the touch sensor 120 is a camera sensor are described below.

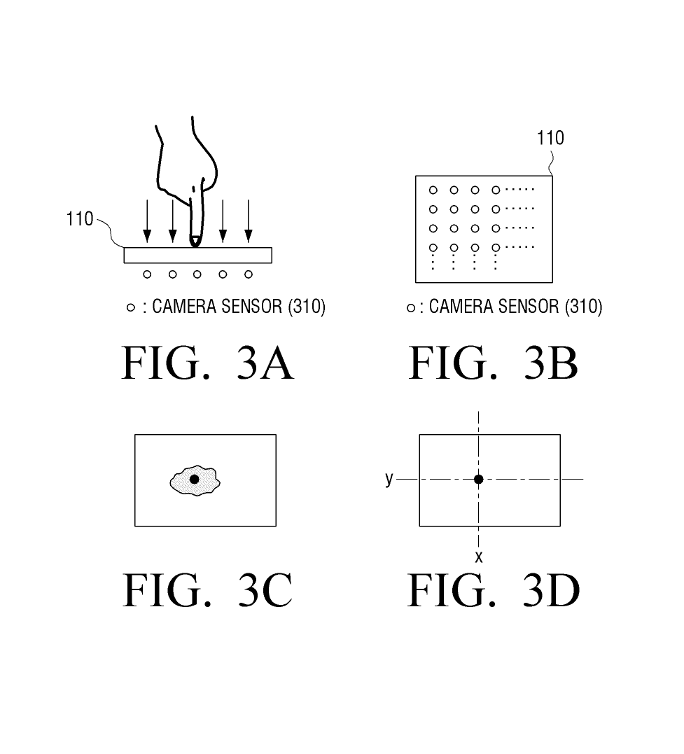

FIG. 3A to 3D illustrate touch sensing operations of a camera sensor 310. Particularly, FIGS. 3A and 3B illustrate a case where a plurality of camera sensors 310 is arranged at a predetermined interval over an entire area of the back side of the display panel 110. In this case, when a user touches the display panel 110 with the user's hand, an external image on the display panel 110 is obtained in a raw data of a shape as shown in FIG. 2C through the camera sensor 310. Next, the controller 130 may process the obtained raw data and obtain a coordinate (x, y) of a touched point, as shown in FIG. 3D.

Specifically, the camera sensor 310 senses the external image entered by using the visible light and detects a touch point. In a case where the camera sensor 310 is arranged on the back side of the display panel 110, the camera sensor 310 may sense the external image not only when the user's hand touches the front surface of the display panel 110 but also when the external display apparatus 210 touches the display panel 110. Also, the camera sensor 310 may sense any flickering of the external image or visible light entered to the display panel 110. Furthermore, even when a plurality of external display apparatuses touches the display panel 110, the camera sensor 310 may also sense each touch, and even when a transparent plate of a certain thickness is provided on the front surface of the display panel 110 and the external display apparatus touches the transparent plate, the camera sensor 310 may detect the touch of the external apparatus and an image on a screen that the external display apparatus 210 displays.

In an exemplary embodiment, the touch sensor 120 may be the photodiode. The photodiode is a kind of light sensor including a semiconductor diode which converts light energy into electric energy. However, the photodiode is not an image sensor which may obtain an image. Therefore, when the touch sensor 120 is the photodiode, an external image may not be sensed unlike a case where the touch sensor 120 is the camera sensor. However, the photodiode may nonetheless sense whether the external object touches the display panel 110 or flickering of the visible light.

The controller 130 controls overall operations of the display apparatus 100. Particularly, the controller 130 may transfer first data to the external display apparatus 210 through a touch area between the external display apparatus and the display panel, and may obtain second data transmitted from the external display apparatus 210 using the touch sensor 120.

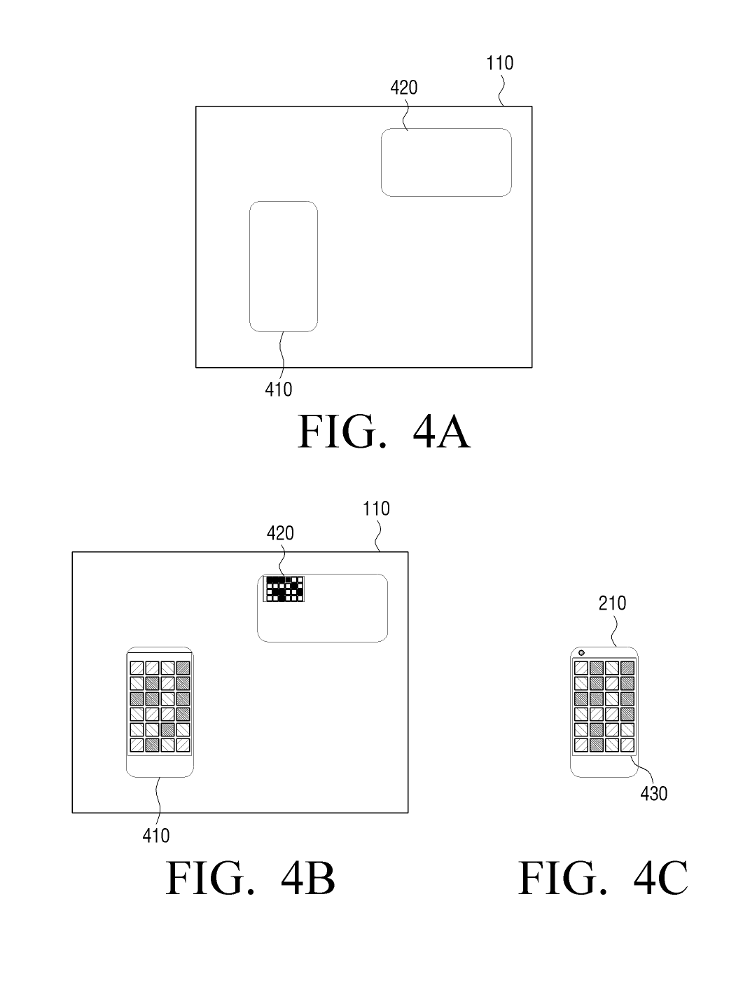

Operations of the controller 130 in an exemplary embodiment where the first data and the second data are patch images are described with reference to FIGS. 1 and 4A to 4C.

FIGS. 4A to 4C show an exemplary embodiment where a plurality of external display apparatuses are touched by the display panel 110 of the display apparatus 100. In this case, a touch area between the display apparatus 100 and the plurality of external display apparatuses may be plural.

FIG. 4A is a view for explaining touch areas 410, 420. In a case where the external display apparatus 210 is placed on the display panel 110 of the display apparatus 100 such that a surface, e.g., the front surface of the external display apparatus 210 faces toward the display panel 110, an area in which the display panel 110 is touched by the external display apparatus 210 is referred to as the touch area. In FIG. 4A, two external display apparatuses touches the display panel 110, forming the two touch areas 410, 420.

To this end, when the external display apparatus 210 touches the display panel 110, the controller 130 may detect the touch through the touch sensor 120 and determine an area where the front surface, e.g., a screen of the external display apparatus 210 is touched as the touch area to be separate from the remaining area.

Meanwhile, the display apparatus 100 performs communication with the external display apparatus 210 through the touch areas 410, 420. Herein, for convenience of explanation, the data transmitted by the display apparatus 100 is referred to as the first data, the data transmitted by the external display apparatus 210 is referred to as the second data, and the first data and the second data each encoded in image formats are referred to as the first patch image and a second patch image.

Herein, a patch image is an image of data encoded according to predetermined rules, for example, a data expression technology of combining colors using, for example, color codes and recording and storing digital information, but is not limited thereto. Thus, any method which may encode data into a corresponding image, decipher (or decode) the encoded image, and obtain data before the encoding may be used.

When the display apparatus 100 has data to transmit to the external display apparatus 210, the controller 130 encodes that data and creates a patch image and displays the created patch image on the touch areas 410, 420. FIG. 4B illustrates a state where the controller 130 encodes each first data to be transmitted to the external display apparatuses 210, which touches the touch areas 410 and 420, into each first patch image and displays the first patch image on the touch areas 410, 420.

The display panel 110 may divide an entire area thereof into a plurality of areas and display different images for each area, and thus the controller 130 may control the display panel 110 to display each second patch image on each touch areas 410, 420.

Accordingly, the external display apparatuses 210 which touch each touch areas 410, 420 may detect the first patch image displayed on each touch area through the camera sensor provided on the front surface of the display panel 110 and obtain each first data.

In FIG. 4B, the first patch image appearing on the touch area 420 is smaller than the first patch image appearing on the touch area 410 and is positioned at a portion of the external display apparatus 210. Herein, in an exemplary embodiment, the first patch image is displayed in accordance with a view angle of the camera sensor of the external display apparatus, and FIG. 4B shows a case where the external display apparatus 210 only has one camera sensor on the front surface thereof.

Meanwhile, the external display apparatus 210 may also display a second patch image corresponding to the second data when the external display apparatus 210 has the second data to transmit to the display apparatus 100. FIG. 4C illustrates an exemplary embodiment where the second patch image is displayed on a screen 430 of the external display apparatus 210. In FIG. 4C, only one external display apparatus 210 displays the second patch image, however, it should be noted that each external display apparatus 210 which touches the touched area may display the second data to be transmitted to the display apparatus 100 on the screen 413 thereof and transmit the second data.

When a plurality of touches occurs within the display panel 110, or when a plurality of external images is detected, the touch sensor 120 of the display apparatus 100 may sense each one separately. Thus, when there are two touch areas as in FIG. 4A and the external display apparatuses 210 which touch each touch areas 410, 420 display the second patch image, the controller 130 of the display apparatus 100 may control the touch sensor 120 to sense each one of the displayed second patch image and decode the sensed second patch image to obtain the second data, respectively.

To this end, the touch sensor 120 may be a camera sensor which may sense images. In addition, the display apparatus 100 may include an additional decoder (not illustrated) which decodes the second patch image obtained through the camera sensor, and the controller 130 may control the decoder unit to decode the second patch image and obtain the second data.

Therefore, not only when one external display apparatus 210 is placed on the display panel 110, but also when a plurality of external display apparatuses 210 are placed on the display panel 110 simultaneously or at different times to produce a plurality of touch areas, the display apparatus 100 may display the first patch image for each touch area, and sense each second patch image to transmit and send the first and the second data with the external display apparatuses 210.

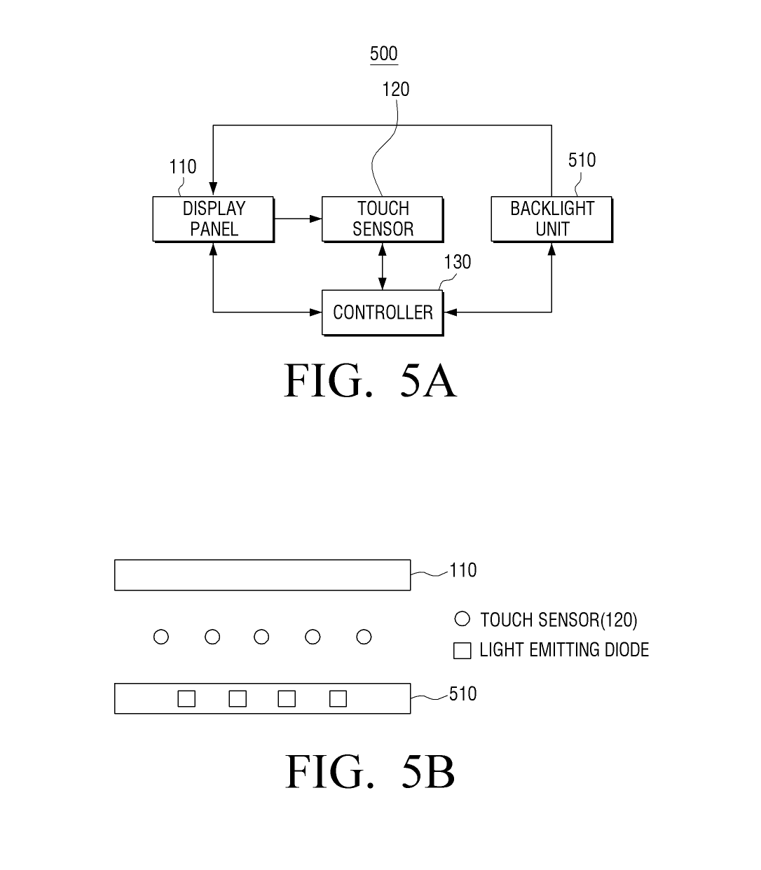

FIGS. 5A and 5B are views illustrating a configuration of a display apparatus according to another exemplary embodiment of the present disclosure. According to FIG. 5A, the display apparatus according to the present disclosure includes a display panel 110, a touch sensor 120, a controller 130, and a backlight unit 510.

The backlight unit 510 is a light source which provides backlight to the display panel 110. More specifically, in a case of a display panel such as an LCD panel which cannot emit light, an image on the display panel can be seen when light is provided from a separate light source, and light which illuminates the display panel from the back side of the display panel is referred to as the backlight.

The backlight unit 510 may use a plurality of light emitting diodes to provide the backlight to the display panel 110. To this end, the backlight unit 510 may include a plurality of cold cathode fluorescent lamps (CCFL) or a plurality of light emitting diodes (LED) but is not limited thereto.

According to FIG. 5B, the backlight unit 510 is located on a back side of the touch sensor 120 relative to the display panel 110, but the backlight unit 510 may be alternatively located in a front side of the touch sensor 120.

The touch sensor 120 may be arranged on the back side of the display panel 110, and may be the camera sensor or the photodiode which senses the visible light which is entered through the front surface of the display panel 110. Therefore, as described above, the touch sensor may sense the flickering of the visible light entered through the front surface of the display panel 110.

The controller 130 may control on/off of one or more light emitting diodes of the backlight unit 510 corresponding to the touch area according to the first data. More specifically, the controller 130 may modulate the first data and alternately turn on or turn off the light emitting diode according to the modulated signal to express the first data. Various well known modulating methods such as frequency modulation, pulse width modulation, pulse code modulation, etc. may be used.

In addition, when a light signal which the external display apparatus emits according to the second data is entered to the touch sensor 120, the controller 130 may demodulate the entered light signal and obtain the second data. That is, the external display apparatus may also turn on or off the light emitting diode within the backlight unit 510 in the same method as the controller 130 expresses the second data. The controller 130 may demodulate the light signal sensed by the touch sensor 120 and restore the second data.

Accordingly, the display apparatus 500 may control turn on/off of the plurality of light emitting diodes and transmit the first data, and demodulate the light signal entered to the touch sensor 120 to obtain the second data, and thus may perform communication of receiving and transmitting data with the external display apparatus.

In addition, the controller 130 may control turn on/off of the light emitting diode corresponding to each of the plurality of touch areas, and transmit the first data for each touch area and obtain the second data from the plurality of external display apparatuses through the touch sensor corresponding to each of the plurality of touch areas, and thus may perform communication with each of the plurality of external display apparatuses.

In addition, when a turn on/off speed of the light emitting diode of the backlight unit 510 is one hundred times per second or higher, a user's eye may not perceive the turn on/off of the light emitting diode, and thus the controller 130 may control on/off of the backlight unit 510 at a speed of one hundred times per second or higher and transmit the first data to the external display apparatus without affecting visibility of the display panel 110.

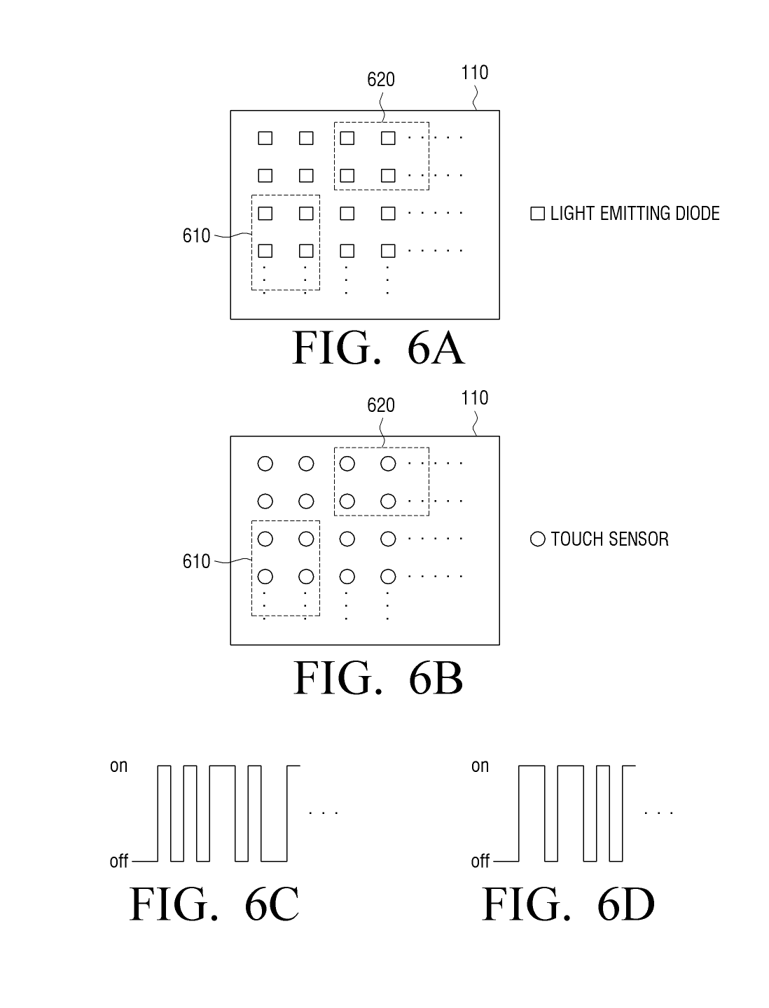

FIGS. 6A to 6D illustrate an exemplary embodiment of transceiving data between external display apparatuses using the display apparatus 500 of FIGS. 5A to 5C. Operations of the display apparatus are described in detail with reference to FIGS. 5A to 5C and 6A to 6D.

FIG. 6A illustrates the display apparatus 500 which transmits the first data to the external display apparatus through touch areas 610, 620, and FIG. 6B illustrates the display apparatus 500 which obtains the second data from the external display apparatus through the touch areas 610, 620. Herein, each of the touch areas 610 and 620 represents an area of the display panel 110 in which the external display apparatus is placed thereon such that the front surface of the external display apparatus faces toward the display panel.

In addition, FIG. 6C is an example waveform of a light signal which is obtained by modulating the first data to be transmitted from the display apparatus 500 to the external display apparatus through on/off control of the backlight unit 510, and FIG. 6D is an example waveform of a light signal which is obtained by modulating the second data to be transmitted from the external display apparatus to the display apparatus 500.

First, operations of the display apparatus 500 which communicates with the external display apparatus through the touch area 610 will be described. Also, communication between the display apparatus 500 and the plurality of external display apparatuses will be described.

With reference to FIG. 6A, in a case where the display apparatus 500 transmits the first data to the external display apparatus through the touch area 610, the controller 130 of the display apparatus 500 may transmit the first data by emitting the light signal as shown in FIG. 6C in which the first data is modulated through controlling on/off of the light emitting diode of the backlight unit 510 according to the first data.

Meanwhile, when the touch sensor 120 is the camera sensor or the photodiode, the touch sensor 120 may sense the light signal such as shown in FIG. 6C which is emitted from the external display apparatus. In addition, with reference to FIG. 6B, in a case where the display apparatus 500 receives the second data transmitted from the external display apparatus, when the light signal modulated from the second data and transmitted from the external display apparatus as is shown in FIG. 6D is entered through the touch sensor 120, the entered light signal may be demodulated through a demodulating unit (not illustrated) to obtain the second data.

Meanwhile, as shown in FIG. 5B and FIG. 6B, a plurality of the touch sensor 120 is placed at a predetermined interval on the back side of the display panel 110 over the entire area thereof, and thus, when a plurality of touches occurs by a plurality of external display apparatuses, each touch area may be detected separately. Therefore, a plurality of touch areas may exist. FIGS. 6A and 6B show the two touch areas 610, 620, but the disclosure is not limited thereto.

In addition, the touch sensor 120 of each touch area 610, 620 may independently sense each light signal emitted from the external display apparatuses, and the controller 130 may demodulate each sensed light signal and obtain the second data.

In addition, as can be seen in FIG. 5B and FIG. 6A, the plurality of light emitting diodes of the backlight unit 510 may also be arranged at a predetermined interval on the back side of the display panel 110, and thus the controller 130 may control on/off of the light emitting diodes within each touch areas 610, 620, and transmit the first data.

That is, when one external display apparatus performs communication with the display apparatus 500 through the touch area 610, another external display apparatus may touch another area 620 of the display panel 110 and independently communicate with the display apparatus 500 through the touch area 620.

Consequently, the display apparatus 500 may use the touch sensor 120 to receive data and transmit data using the backlight unit 510, thereby communicating with each of the plurality of external display apparatuses without affecting the display panel 110.

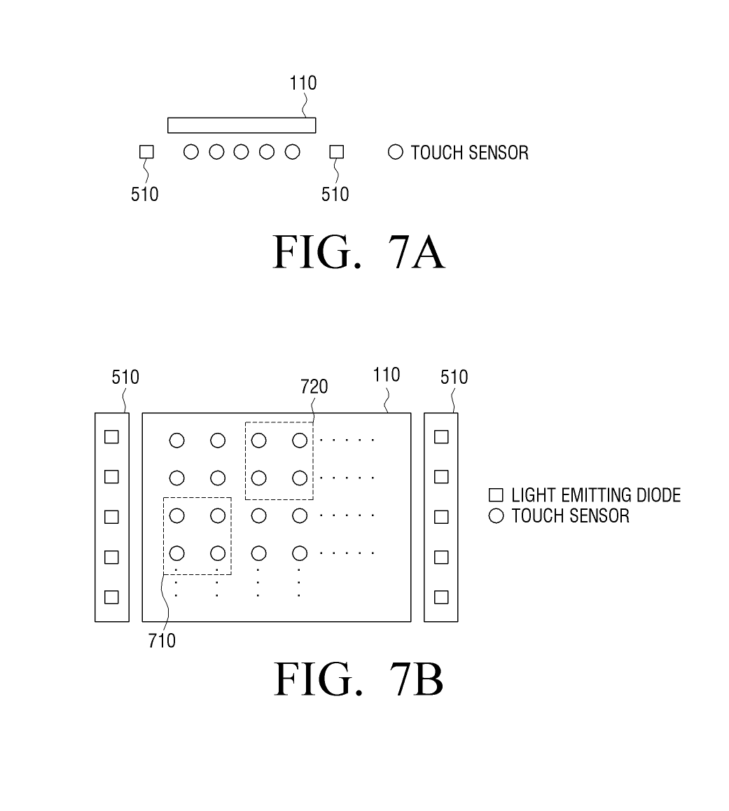

Meanwhile, FIGS. 7A and 7B illustrate another exemplary embodiment of a display apparatus.

In the exemplary embodiment of FIGS. 7A and 7B, unlike of the exemplary embodiments of FIGS. 5A, 5B and 6A to 6D, it can be seen that the backlight unit 510 is placed at a side of the display panel 110. In this case, the light emitting diodes of the backlight unit 510 provide light source to the entire display panel 110, and thus the controller 130 may control on/off of the backlight 510 and transmit only the light signal corresponding to the first data through the entire display panel 110. Therefore, the first data that the display apparatus 500 transmits through two touch areas (710, 720 in FIG. 7B) are the same.

However, in this exemplary embodiment, the touch sensor 120 is placed at a predetermined interval on the back side of the display panel 110 over an entire portion thereof in the same manner as FIG. 5B and FIG. 6B, and thus the touch sensor 120 may sense each touch separately and obtain each second data even when touches by a plurality of external display apparatuses occur simultaneously or at different times.

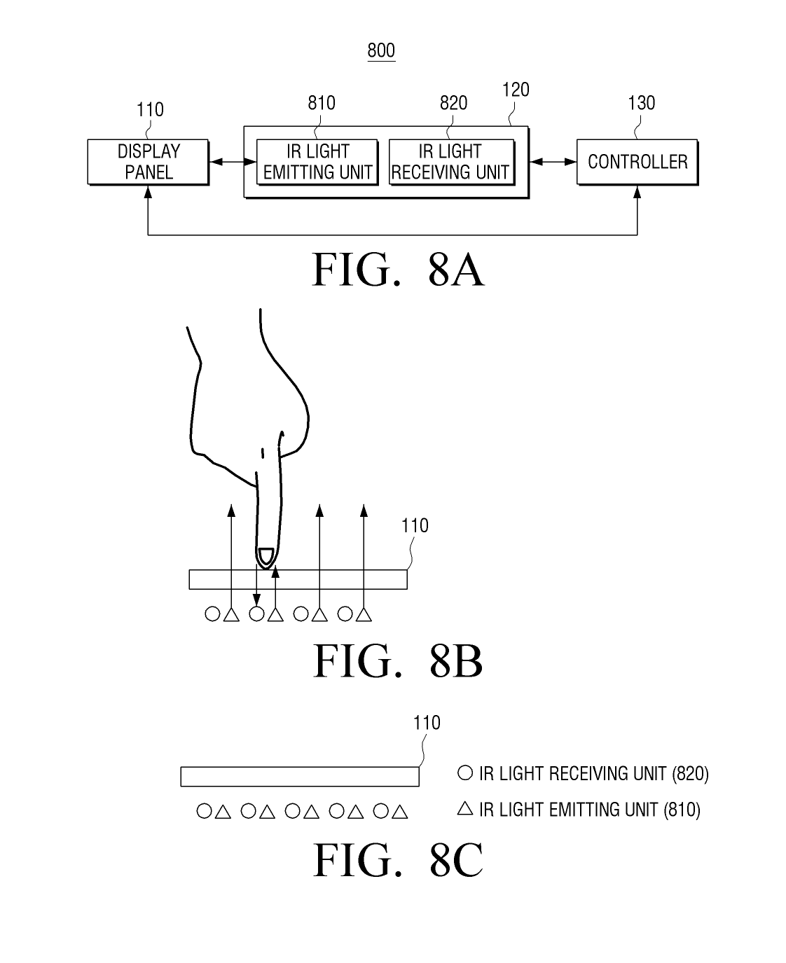

FIGS. 8A to 8C are views illustrating a configuration of the display apparatus and operations of an infrared (IR) sensor in a case where the touch sensor includes the IR sensor. According to FIG. 8A, a display apparatus 800 includes a display panel 110, a touch sensor 120 which includes an IR light emitting unit 810 and an IR light receiving unit 820, and a controller 130.

In this exemplary embodiment, the touch sensor 120 includes the IR sensor. The IR sensor includes the IR light emitting unit 810 and the IR light receiving unit 820, and the IR light emitting unit 810 may emit an IR signal, and the IR light receiving unit 820 may receive the IR signal.

FIG. 8B is a view for explaining touch sensing operations through the IR sensor of the display apparatus 800. When the user touches the display panel 110 with the user's hand, the IR light of the touched point emitted by the IR light emitting unit 810 is reflected by the user's hand and is received by the IR light receiving unit, thereby sensing the touched point.

Accordingly, the IR sensor may sense whether there is a touch by an external object including the user's hand on the display panel 110. In addition, the IR sensor may sense each touch even when there is a plurality of touches on the display panel 110. In addition, the IR light receiving unit 820 may be used for the display apparatus 100 to obtain the second data transmitted from the external display apparatus.

To this end, as illustrated in FIG. 8C, the IR sensor may be arranged on the back side of the display panel 110 at a predetermined interval over an entire portion thereof. Particularly, the IR light emitting unit 810 and the light receiving unit 820 may be arranged in one pair, but are not limited thereto.

The controller 130 controls on/off of the IR light emitting unit 810 to emit the IR signal according to the first data and transmits the first data to the external display apparatus, and when the IR signal that the external display apparatus emits according to the second data is received through the IR light receiving unit 820, the controller 130 may demodulate the received IR signal and obtain the second data.

Herein, controlling the on/off of the IR light emitting unit 810 to emit the IR signal according to the first data refers to modulating the first data, storing the first data in the IR signal, and transmitting the IR signal to the external display apparatus. Meanwhile, modulating and demodulating data through controlling on/off of the IR signal is a well known technology, and explanation thereof is omitted.

Accordingly, the display apparatus 800 may control the on/off of the IR light emitting unit 810 and transmit the first data and demodulate the IR signal entered to the IR light receiving unit 820 to obtain the second data, thereby enabling communication of receiving and transmitting data with the external display apparatus.

In addition, the controller 130 controls the on/off of the IR light emitting unit 810 corresponding to each of a plurality of touch areas, transmits the first data for each touch area, and obtains the second data from each of the plurality of external display apparatuses through the IR light receiving unit 820 corresponding to each of the plurality of touch areas, thereby enabling communication with each of the plurality of external display apparatuses.

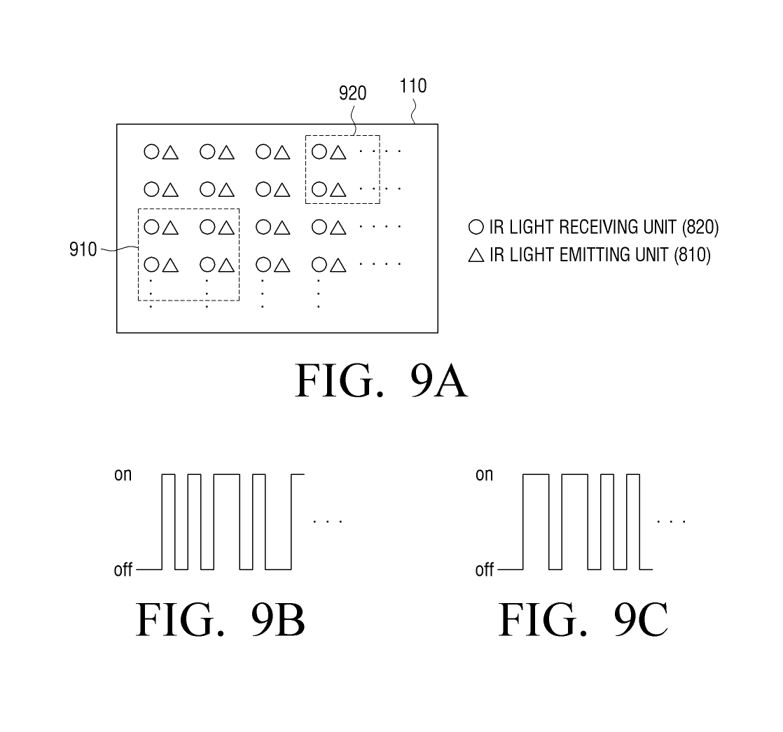

FIGS. 9A to 9C illustrate an exemplary embodiment of transceiving data with an external display apparatus using the display apparatus 800 of FIG. 8A. Operations of the display apparatus 800 are explained in further detail with reference to FIGS. 8 and 9A to 9C below.

FIG. 9A illustrates the display apparatus 800 which communicates with the external display apparatus through touch areas 910, 920. Herein, each of the touch areas 910 and 920 represents a touch area where external display apparatuses are placed on the display panel 110 of the display apparatus 800 such that the front surface of the external display apparatus is placed to face toward the display panel side 110. In addition, FIG. 9B is an example waveform of an IR signal obtained by modulating the first data to be transmitted from the display apparatus 800 to the external display apparatus through the on/off of the IR light emitting unit 810, and FIG. 9C is an example waveform of an IR signal obtained by modulating the second data to be transmitted from the external display apparatus to the display apparatus 800.

In FIGS. 9A to 9C, in a case where the display apparatus 800 transmits the first data to the external display apparatus through the touch area 910, the controller 130 may emit the IR signal, as shown in FIG. 9B, modulated from the first data through controlling on/off of the first data and thus transmit the first data.

In addition, in a case where the display apparatus 800 receives the second data transmitted from the external display apparatus, the IR signal, as shown in FIG. 9C, transmitted from the external display apparatus, is received through the IR light receiving unit 820 within the touch area 910 and the controller 130 may demodulate the received IR signal through the demodulating unit (not illustrated) to obtain the second data.

Meanwhile, as can be seen in FIG. 9A, the IR light emitting unit 810 and the IR light receiving unit 820 are arranged on the back side of the display panel 110 at a predetermined interval over an entire portion thereof, and thus it is possible to sense each touch separately even when a plurality of touches occur by a plurality of external display apparatuses simultaneously or at different times. Therefore, there may be a plurality of touch areas produced simultaneously or with a time difference, and it is also possible to transceive the IR signal with different external display apparatuses through each touch area. FIG. 9A illustrates a case where there are the two touch areas 910, 920, but it is not limited thereto.

Therefore, when one external display apparatus performs communication with the display apparatus 800 through the touch area 910, another external apparatus may touch another area 920 and independently perform communication with the display apparatus 800 through the touch area 920.

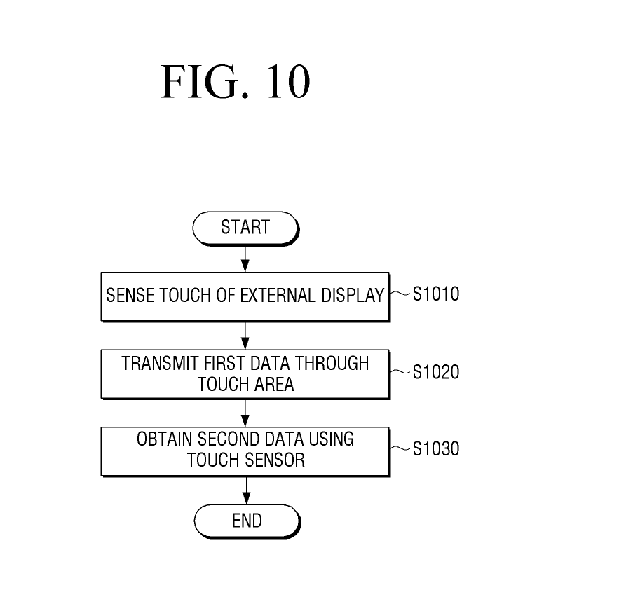

FIG. 10 is a flowchart illustrating a method of communication between display apparatuses according to exemplary embodiment of the present disclosure.

With reference to FIG. 10, according to an exemplary embodiment of a communication method of the display apparatus, the controller 130 of the display apparatus 100 transmits the first data from the external display apparatus to the external display apparatus through the touch area touched by the external display apparatus on the display panel 110 (S1020), when a touch by the display screen 211 of the external display apparatus 211 is sensed on the display panel 110 of the display apparatus 100 (S1010). Also, the touch sensor 120 is used to obtain the second data transmitted from the external display apparatus (S1030).

Data transmission and receiving may be embodied differently according to various exemplary embodiments of the present disclosure as described above.

For example, a patch image may be used to transceiver data. More specifically, transmitting of data may be performed by creating a first patch image corresponding to the first data and displaying the created first patch image within the touch area, and the receiving of data may be performed by decoding a second patch image, when the second patch image corresponding to the second data is displayed on the display screen of the external display apparatus and is sensed by the touch sensor 120.

Otherwise, data maybe transceived in a method of adjusting the backlight using light emitting diodes. In this case, the display apparatus may further include the backlight unit 510 which provides backlight to the display panel using a plurality of light emitting diodes. More specifically, transmitting of data may be performed by controlling on/off of the light emitting diode corresponding to the touch area according to the first data, and the receiving of data may be performed by demodulating a light signal and obtain the second data when the light signal is entered to the touch sensor 120 which the external display apparatus emits according to the second data.

In the aforementioned exemplary embodiment, the backlight is adjusted locally, but it should be noted that, in an alternative embodiment, on/off of the backlight of an entire screen may be controlled altogether. More specifically, the transmitting of data may be performed by controlling on/off of the backlight unit 510 according to the first data, and the receiving of data may be performed by demodulating the light signal to obtain the second data when the light signal which the external display apparatus emits according to the second data is entered to the touch sensor 120.

In another exemplary embodiment, the IR light may be used to transceiver data. In this case, the touch sensor 120 may include the IR light emitting unit 810 and IR light receiving unit 820 arranged on the back surface of the display panel 110. In addition, the transmitting of data may be performed by controlling on/off of the IR light emitting unit 810 to emit the IR signal according to the first data, and the receiving of the data may be performed by demodulating the received IR signal and obtain the second data, when the IR signal which the external display apparatus emits according to the second data is received through the IR light receiving unit 820.

In addition, the touch sensor may be arranged on the back surface of the display panel and may be the camera sensor or the photodiode which senses visible light entered through the front surface of the display panel.

In addition, the display apparatus may be the table-type display apparatus, and the external display apparatus may be the portable display apparatus. In the case of the table-type display apparatus, a table surface may be significantly distanced away from the display panel, and the table surface may be covered with a transparent plate.

In this case, since the touch sensor is located on the back surface of the display panel, when the external display apparatus is touched on the transparent plate, the display apparatus may detect the touch. In addition, since a certain distance is secured between the display panel and external display apparatus, when the external display apparatus has only one camera, a view angle equal to or greater than a certain angle may be secured, and surrounding light may be introduced between the display panel and the touch area, thereby securing light needed for image perception.

In an exemplary embodiment, an additional optical system such as a lens may be provided near the display panel or between the display panel and the transparent plate, to enable effective transmission of visible light or IR light between the display apparatus and external display apparatus.

As described above, according to various exemplary embodiments of the present disclosure, it is possible to transmit and receive data using visible light or IR light without using an additional chip or hardware for communication.

Meanwhile, communication methods of the display apparatus according various exemplary embodiments may be embodied in software and mounted to the display apparatus.

More specifically, according to an exemplary embodiment of the present disclosure, in the display apparatus, a non-transitory computer readable medium may be installed which stores a program for performing touch sensing to sense whether the display screen of the external display apparatus touches the display panel of the display apparatus, transmitting the first data to the external display apparatus through the touch area between the external display apparatus and the display panel, and receiving the second data transmitted from the external display apparatus by using the touch sensor.

A non-transitory computer readable medium refers to a medium readable by a computer and is capable of storing data semi-permanently. More specifically, the aforementioned various programs may be stored in a non-transitory computer readable medium such as a CD, DVD, hard disk, Blue-ray disk, USB, memory card, ROM, etc.

Although a few embodiments of the inventive concept have been shown and described, it would be appreciated by those skilled in the art that changes may be made in this embodiment without departing from the principles and spirit of the inventive concept, the scope of which is defined in the claims and their equivalents.

What is claimed is:

1. A display apparatus comprising:
a display panel;
a touch sensor which senses whether a display screen of an external display apparatus is touched on the display panel; and
a controller which transmits first data to the external display apparatus through a touch area between the display panel and the display screen of the external display apparatus, and obtains second data transmitted from the external display apparatus using the touch sensor.

2. The display apparatus according to claim 1, wherein the controller generates a first patch image corresponding to the first data and displays the generated first patch image on the touch area, and
when a second patch image corresponding to the second data is displayed on the display screen of the external display apparatus and is sensed by the touch sensor, the controller decodes the second patch image to obtain the second data.

3. The display apparatus according to claim 1, further comprising a backlight unit which provides backlight to the display panel using a plurality of light emitting diodes,
wherein the controller controls on/off of a light emitting diode corresponding to the touch area among the plurality of light emitting diodes according to the first data, and
when a light signal which the external display apparatus emits according to the second data is entered to the touch sensor, the controller demodulates the light signal to obtain the second data.

4. The display apparatus according to claim 1, further comprising a backlight unit which provides backlight to the display panel,
wherein the controller controls on/off of the backlight unit according to the first data, and
when a light signal which the external display apparatus emits according to the second data enters the touch sensor, the controller demodulates the light signal to obtain the second data.

5. The display apparatus according to claim 1, wherein the touch sensor comprises an infrared (IR) light emitting unit and an IR light receiving unit which are arranged on a back surface of the display panel, and
the controller controls on/off of the IR light emitting unit to emit an IR signal according to the first data, and
when an IR signal that the external display apparatus emits according to the second data is received through the IR light receiving unit, the controller demodulates the received IR signal to obtain the second data.

6. The display apparatus according to claim 1, wherein the touch sensor is arranged on a back surface of the display panel and is at least one of a camera sensor or a photodiode which senses visible light entered through a front surface of the display panel.

7. The display apparatus according to claim 1, wherein the display apparatus is a table-type display apparatus, and
the external display apparatus is a portable display apparatus.

8. A communication method of a display apparatus, comprising:
determining whether a display screen of an external display apparatus touches a display panel of the display apparatus;
if it is determined that the display screen of the external display apparatus touches the display panel, transmitting first data to the external display apparatus through a touch area between the external display apparatus and the display panel; and
receiving second data transmitted from the external display apparatus using a touch sensor.

9. The communication method according to claim 8, wherein the transmitting comprises generating a first patch image corresponding to the first data and displaying the generated first patch image within the touch area, and
when a second patch image corresponding to the second data is displayed on the display screen of the external display apparatus and is sensed by the touch sensor, the receiving comprises decoding the second patch image to obtain the second patch image.

10. The communication method according to claim 8, further comprising providing backlight to the display panel using a backlight unit comprising a plurality of light emitting diodes, and
wherein the transmitting comprises controlling on/off of a light emitting diode corresponding to the touch area among the plurality of light emitting diodes according to the first data, and
when a light signal which the external display apparatus emits according to the second data is entered to the touch sensor, the receiving comprises demodulating the light signal to obtain the second data.

11. The communication method according to claim 8, further comprising providing backlight to the display panel using a backlight unit, and
wherein the transmitting comprises controlling on/off of the backlight unit according to the first data, and
when a light signal which the external display apparatus emits according to the second data is entered to the touch sensor, the receiving comprises demodulating the light signal to obtain the second data.

12. The communication method according to claim 8, wherein the touch sensor comprises an infrared (IR) light emitting unit and an IR light receiving unit which are arranged on a back surface of the display panel,
the transmitting comprises controlling on/off of the IR light emitting unit to emit an IR signal according to the first data, and
when an IR signal which the external display apparatus emits according to the second data is received through the IR light receiving unit, the receiving comprises demodulating the received IR signal to obtain the second data.

13. The communication method according to claim 8, wherein the touch sensor is arranged on a back surface of the display panel and is at least one of a camera sensor or a photo diode which senses visible light entered through a front surface of the display panel.

14. The communication method according to claim 8, wherein the display apparatus is a table-type display apparatus, and
the external display apparatus is a portable display apparatus.

15. A non-transitory record medium where a program for performing a communication method of a display apparatus is stored, the communication method comprising:
touch sensing whether a display screen of an external apparatus touches a display panel of the display apparatus;
transmitting first data to the external display apparatus through a touch area between the external display apparatus and the display panel; and
receiving second data from the external display apparatus using a touch sensor.

16. The non-transitory record medium of claim 15, wherein the transmitting comprises generating a first patch image corresponding to the first data and displaying the generated first patch image within the touch area, and
when a second patch image corresponding to the second data is displayed on the display screen of the external display apparatus and is sensed by the touch sensor, the receiving comprises decoding the second patch image to obtain the second patch image.

17. The non-transitory record medium of claim 15, further comprising providing backlight to the display panel using a backlight unit comprising a plurality of light emitting diodes, and
wherein the transmitting comprises controlling on/off of a light emitting diode corresponding to the touch area among the plurality of light emitting diodes according to the first data, and
when a light signal which the external display apparatus emits according to the second data is entered to the touch sensor, the receiving comprises demodulating the light signal to obtain the second data.

18. The non-transitory record medium of claim 15, wherein the communication method further comprises providing backlight to the display panel using a backlight unit, and
wherein the transmitting comprises controlling on/off of the backlight unit according to the first data, and
when a light signal which the external display apparatus emits according to the second data is entered to the touch sensor, the receiving comprises demodulating the light signal to obtain the second data.

19. A method of driving a light source of a display apparatus, the method comprising:
determining whether a display screen of an external display apparatus touches a display panel of the display apparatus; and
if it is determined that the display screen of the external display apparatus touches the display panel, controlling on/off of at least one light source corresponding to a touch area between the external display apparatus and the display panel according to data to be transmitted to the external display apparatus.

20. The method of claim 19, wherein the display apparatus comprises a touch sensor arranged on a back surface of the display panel and is at least one of a camera sensor, a photo diode, or an infrared (IR) light sensor, and
wherein the determining is performed by using the touch sensor.
